(19) United States
(12) Patent Application Publication
(10) Pub. No.: US 2014/0282128 A1
(43) Pub. Date: Sep. 18, 2014

(54) System and Method for a User Interface Controller for Mandatory and Shared User Interface Functions

(71) Applicant: SAP AG, Walldorf (DE)

(72) Inventor: Wenli Zhang, Palo Alto, CA (US)

(73) Assignee: SAP AG, Walldorf (DE)

(21) Appl. No.: 13/839,866

(22) Filed: Mar. 15, 2013

(51) Int. Cl. G06F 3/0484

(52) U.S. Cl. CPC G06F 3/0484
USPC 715/762

(57) ABSTRACT

Systems and methods for sharing mandatory and shared user interface (UI) functions among UIs that share a common main business object are disclosed. Such embodiments include a UI controller having a superclass for implementing mandatory UI functions, a delegation class for implementing shared UI functions, and a concrete UI controller classes corresponding to concrete UIs associated with the same business object. The concrete UI classes inherit the superclass and selectively delegate to the delegation class. Thus, a concrete UI can be instantiated and operated using a corresponding concrete UI controller class. When a UI action is received, the UI controller can trigger the corresponding mandatory or shared UI functions. The UI controller can handle setting common UI parameters, UI function specific and default parameters. The separate handling of the mandatory and shared UI functions increases the flexibility, organization, and efficiency of developing and implementing multiple UIs.

### BACKGROUND

The present disclosure relates to user interfaces (UIs) that are associated with a common main business object, and in particular, systems and methods for a user interface (UI) controller for handling mandatory and shared functions among such related UIs.

Unless otherwise indicated herein, the approaches described in this section are not prior art to the claims in this application and are not admitted to be prior art by inclusion in this section.

Many applications include UIs, such as graphical user interfaces (GUIs), to provide a mechanism for users to interact with and manipulate the applications. For applications using an object-oriented programming language, the UIs are normally supported by one or more business objects. One of the business objects is usually considered to be the main business object from which multiple UIs can be instantiated. For instance, in large-scale applications, e.g., an enterprise resource planning (ERP) application, it is common for many UIs to use or operate on the same main business object to display or analyze various aspects of a particular business. One UI may be used to retrieve accounting information from a particular main business object, while another UI may be used to analyze human resources information from the same main business object.

Each UI can include shared UI functions as well as shared and mandatory functions. The shared UI functions are the functions that are used to perform the task specific to the UI, e.g., analyze accounting data or analyze human resource data. Shared functions are the functions that are shared among all the UIs with the same main business object. The mandatory functions include functions that are common to all of the UIs associated with a particular main business object. Some of the mandatory functions are functions that are required by the application for the UI and the shared UI functions to interact with the application or the main business object in a prescribed manner. Other mandatory function can be set to dictate the look and feel of the UIs to guarantee a predetermined or approved user experience or product branding. For example, the mandatory functions in each UI can include functionality and layout of controls for invoking other UIs, e.g., placement of certain tabs and pull-down menus, or for closing the application. The UI-specific functions are the functions defined with some particular data display of or data analysis in mind specific to that particular UI.

Traditionally, in the development of large-scale applications, each UI must be coded to include the mandatory UI functions, as well as any shared UI functions. This leads to the mandatory UI functions being coded repeatedly. In addition, while each shared UI function can be unique to a particular UI, it is common for multiple UIs to include similar, if not identical, shared UI functions. Accordingly, many of the shared UI functions may also end up being coded repeatedly.

The repeated coding of the mandatory and shared UI functions can lead to many lines of redundant code resulting in wasted programming and computing resources. The inefficiency of these types of UI development and execution systems is further compounded when multiple developers are implementing individual or unique UI implementations for the mandatory and/or optional shared UI functions for multiple UIs. Each particular implementation may or may not be compatible or entirely consistent with the other implementations of the mandatory or shared UI functions. Embodiments of the present disclosure address these and other issues.

### SUMMARY

Embodiments of the present disclosure improve systems and methods for mandatory and shared user interface (UI) functions among a plurality of user interfaces associated with a common main business object. One embodiment of the present disclosure is a method that includes providing a user interface controller that comprises a superclass for implementing multiple mandatory user interface functions, a delegation class for implementing multiple shared user interface functions, and multiple concrete user interface controller classes corresponding to multiple concrete user interfaces that are associated with a main business object. The concrete user interface classes inherit the mandatory user interface functions from the superclass and selectively delegate shared UI functions to the delegation class. Such embodiments may also include receiving a first function call from a first concrete user interface of multiple concrete user interfaces instantiated from the main business object, instantiating, in response to the first function call, a first corresponding concrete user interface controller class, and executing a first user interface function from the first corresponding concrete user interface controller class. As used herein, the term “concrete user interface” refers to expressions of a UI that define a number of attributes in definite terms of look, feel, and functionality of the UI that is presented to a user. The attributes in a concrete UI can be expressed in terms of UI layouts and UI actions, and/or the manner in which the UI layouts and UI actions interact.

In one embodiment, the first user interface function includes a first shared user interface function.

In one embodiment, shared UI functions can include a selection of one or more shared UI functions or UI actions in the shared function delegation class that is unique, or specific, to the purpose or use of a particular concrete UI. The shared function delegation class can be common to all the UIs with the same main business object. In one particular embodiment, the selection of one or more shared UI functions can include UI functions common to one or more concrete UIs. In other embodiments, the selection of one or more shared UI functions can include UI functions completely unique to a particular concrete UI. The shared UI functions can include functionality for accessing, manipulating, or analyzing data in the main business object or any other business object associated with the main business object of an application.

In some embodiments, the main business objects can be instantiated to implement one or more applications. In one particular embodiment, the main business object can include models or definitions that determine the manner in which concrete UIs access, manipulate, or analyze data in the main business object or other business objects with which the main business object is associated. In one embodiment, the main business object may include a set of instance variables or properties, known as attributes, and associations with other business objects in the business object layer.

In one embodiment, executing the first shared UI function includes instantiating the delegation class.

In one embodiment, instantiating the first shared UI function comprises executing a delegation class method in the delegation class.

In one embodiment, the method comprises passing, by the computer system, a concrete user interface specific parameter associated with the first concrete user interface to the delegation class method.

In one embodiment, the method comprises setting default parameters associated with the plurality of concrete user interfaces in the delegation class method.

In one embodiment, the mandatory user interface functions comprise user interface functions for passing user interface specific parameters to the first user interface function

One embodiment includes a non-transitory computer readable medium containing instructions, that when executed by a computer processor configures the computer processor for: providing a user interface controller having a superclass for implementing multiple mandatory user interface functions, a delegation class for implementing multiple specific functions, and multiple concrete user interface controller classes corresponding to a plurality of concrete user interfaces that are associated with a main business object. The concrete user interface classes inherit the mandatory user interface functions from the superclass and selectively delegate shared UI functions to the shared function delegation class. The instructions can further cause the computer processor for receiving a first function call from a first concrete user interface from the multiple concrete user interfaces instantiated from the main business object, instantiating in response to the first function call, a first corresponding concrete user interface controller class from the multiple concrete user interface controller classes, and executing a first user interface function from the first corresponding concrete user interface controller class.

One embodiment includes a system having one or more computer processors and a non-transitory computer readable medium containing instructions, that when executed by configures the one or more computer processors for: providing a user interface controller having a superclass for implementing multiple mandatory user interface functions, a delegation class for implementing multiple specific functions, and multiple concrete user interface controller classes corresponding to a plurality of concrete user interfaces that are associated with a main business object. Concrete user interface classes inherit the mandatory user interface functions from the superclass and selectively delegate shared UI functions to the delegation class. The instructions can further cause the computer processor for receiving a first function call from a first concrete user interface from the multiple concrete user interfaces instantiated from the main business object, instantiating in response to the first function call, a first corresponding concrete user interface controller class from the multiple concrete user interface controller classes, and executing a first user interface function from the first corresponding concrete user interface controller class.

The following detailed description and accompanying drawings provide a better understanding of the nature and advantages of the present disclosure.

### BRIEF DESCRIPTION OF THE DRAWINGS

FIG. 1 is a schematic representation of a framework for sharing mandatory and shared user interface functions according to one embodiment of the present disclosure.

FIG. 2 is a block diagram of a framework for sharing mandatory and shared UI functions according to one embodiment of the present disclosure.

FIG. 3 is a block diagram of another framework for sharing mandatory and shared UI functions according to one embodiment of the present disclosure.

FIG. 4 is flowchart for a method for sharing mandatory and shared UI functions according to one embodiment of the present disclosure.

FIG. 5 a schematic diagram for a computer system that can be used to implement various embodiments of the present disclosure.

### DETAILED DESCRIPTION

Described herein are techniques for systems and methods for a framework that includes a user interface (UI) controller for sharing mandatory and shared UI functions among a plurality of UIs associated with a common main business object. In the following description, for purposes of explanation, numerous examples and specific details are set forth in order to provide a thorough understanding of the present disclosure. It will be evident, however, to one skilled in the art that the present invention as defined by the claims may include some or all of the features in these examples alone or in combination with other features described below, and may further include modifications and equivalents of the features and concepts described herein.

Embodiments of the present disclosure are directed to systems and methods for a framework that includes a UI controller that allows for fast and efficient development and execution of multiple UIs that are associated with the same main business object. In one embodiment, the UI controller is a layer in computer system or application. In one specific example, a UI controller includes multiple concrete UI controller classes corresponding to the multiple concrete UIs associated with the main business object for a particular application. The concrete UI controller classes may include a construct that may be instantiated to create provide functionality to corresponding concrete UIs. The framework of the UI controller separates the mandatory functions from the shared UI functions. The mandatory functions are included in a superclass. The shared UI functions are included in a shared function delegation class. In one embodiment, any concrete UI can call some UI specific portion of the functions in the shared function delegation class. In such embodiments, each concrete UI controller class can inherit the mandatory functions from the mandatory function superclass, and/or delegate the shared UI functions to the shared function delegation class. Accordingly, when any of the shared UI functions are triggered by a UI action in one of the concrete UIs, the concrete UI controller class that corresponds to the concrete UI in which the UI action was performed can be instantiated. When the appropriate concrete UI controller class is instantiated, the resulting implementation automatically includes the mandatory functions inherited from the mandatory functions superclass, and any selection of the shared UI functions delegated to the shared function delegation class. In one embodiment, each of the mandatory and shared UI functions instantiated in response to the UI action in the concrete UI can selectively include default or UI specific parameter settings. The determination as to whether to use the default parameter in the delegation class or to use the UI specific parameter is passed from the concrete UI can be determined in the concrete UI, the UI action, or the concrete UI controller class. As such, the mandatory functions and the shared UI functions can be flexibly implemented using any combination of UI specific, end user specified, and default parameter settings. Further examples and alternative embodiments are described below.

FIG. 1 illustrates a graph 100 of multiple concrete UIs 110 used with a common main business object. As shown, each of the concrete UIs 110 includes each of the mandatory functions 115. In one embodiment, mandatory functions 115 can include UI and/or application functions required by the particular application in which the concrete UIs 110 are implemented. For example, the mandatory functions 115 can include functions or actions displayed in a drop-down menu of a graphical user interface (GUI), e.g., open file, save file, open new UI, close a UI, etc., common to all UIs for a particular application. The mandatory functions 115 may include system required implementation functions in order for the UI controller function with the concrete UI 110. In another embodiment, the mandatory functions 115 may include functionality for accessing or manipulating the underlying main business object, or any business object to which the main object provides access, using the Shared UI functions 120. In contrast, the Shared UI functions 120 can include functions or actions that are only required by some of the concrete UIs 110. The Shared UI functions 120 can include functions or actions necessary for achieving a particular rendering or specific manipulation of the main business object, or one or more other business objects accessed by the main business object. Such functions or actions can include methods for sorting, filtering, deleting, correcting, aggregating, etc., information of the common main business object. In some embodiments, the Shared UI functions 120 can also include non-generic user defined functions.

As shown in the example graph 100, each of the M concrete UIs 110 is connected to each of the N mandatory functions 115 to indicate that each of the M concrete UIs 110 includes all the mandatory functions 115, where N and M are natural numbers. However, each of the concrete UIs 110 is only connected to the shared UI functions 120 needed or selected for that particular concrete UI. As shown in the example graph 100, concrete UI 110-1 only includes shared UI functions 120-1 and 120-2. Concrete UI 110-2 only includes shared UI function 120-2. Concrete UI 110-3 includes shared UI functions 120-3 and 120-P, where P is a natural number. Finally, concrete UI 110-M only includes shared UI function 120-P.

Graph 100 also illustrates the separation of the mandatory functions 115 from the shared UI functions 120 in the framework of the UI controller, according to various embodiments of the present disclosure. By separating the mandatory functions 115 from the shared UI functions 120, UI developers need not be concerned with the details of the mandatory functions 115 when considering and customizing the various aspects of the shared UI functions 120 of the UI. Accordingly, significant simplification and increased efficiency can be achieved in the development and implementation of multiple UIs associated with the same main business object.

FIG. 2 is a block diagram of a framework 200 that includes a UI controller layer 210 for handling mandatory functions 115 and shared UI functions 120 for multiple concrete UIs 110, according to various embodiments of the present disclosure. The framework 200 can include multiple layers. In one embodiment, the framework 200 can include a concrete UI layer 220, a UI controller layer 210, and a model or business objects layer 230.

The framework 200 can be understood by examining the various layers from the bottom up. The model or business objects layer 230 stores and handles the processing of the main business object 231 and any other business objects 233. Accordingly, the main business object 231 and the other business objects 233 can reside in the business objects layer 230 of a particular local or online application.

The concrete UI layer 220 references the UI controller layer 210 and the main business object 231 and other business objects 233 in business objects layer 230. In one embodiment, the UI controller layer can include a computer executed application module that handles the instantiation of the UI controller classes 211, mandatory UI functions superclass 213, and the shared function delegation class 215. The concrete UI controller classes 211 in the UI controller layer 210 can reference mandatory UI functions superclass 213 and shared function delegation class 215. Accordingly, each of the concrete UI controller classes 211 can automatically include all of the mandatory UI functions in superclass 213. However, each concrete UI controller class 211 can include only functions selected by a UI developer from the shared function delegation class 215 for a particular concrete UI 110. Accordingly, each concrete UI 110 in the concrete UI layer 220 can include some or all of the shared UI functions available in the shared function delegation class 215. As such, the concrete UI controller classes 211 can inherit the mandatory UI function superclass 213 and selectively delegate shared UI functions 120 to the shared function delegation class 215 in response to UI actions 223 performed in, or function calls received from, the concrete UI layer 220. As used herein, the term concrete UI controller class 211 can refer to any construct that can be used to create instances of itself. In one specific embodiment, the concrete UI controller class 211 can define the variables or methods that allow for the instances of the UI controller class to maintain state or to perform functions. According, an instantiated UI controller class 211 can be called by a corresponding concrete UI to perform various types of data handling and function processing.

When any concrete UI controller class 211 is instantiated in response to a UI action 223 in a corresponding concrete UI 110, it can instantiate the entire shared function delegation class 215. The shared UI function 120 that corresponds to the UI action 223 can be delegated to the instantiated shared function delegation class 215. However, before the shared UI function 120 is delegated to the shared function delegation class 215, embodiments of the present disclosure can set any number of settings or parameters for functions implemented in the shared function delegation class 120. If the specific concrete UI 110 includes its own UI specific settings, then those settings can be passed to the shared function delegation class 215 by the concrete UI controller 210. However, if the specific concrete UI 110 does not include its own UI specific settings or parameters, then the UI controller 210 can use default parameter settings common to all UIs associated with the concrete UI controller 210 classes 211. Default parameters can be included in the delegation class 215. In other embodiments, a combination of UI specific settings and default settings can be used when instantiating or executing the mandatory and shared functions.

The UI layer 220 is provided for rendering concrete UIs 110 with specific UI layouts 221 and UI actions 223. Each of the concrete UI controller classes 211 can be instantiated in response to a shared UI function call that results from one of the UI actions 223 in a corresponding concrete UI 110 in the UI layer 220. Accordingly, there can be a one-to-one relationship between a specific concrete UI 110 and a corresponding concrete UI controller class 211. In one embodiment, the UI layer 220 can render a particular UI according to the specifications or definitions included in a specific corresponding concrete UI controller class 211. The specifics of the UI layout 221 and UI actions 223 can be instantiated from definitions included in a particular concrete UI controller class 211. In another embodiment, the UI layout 221 of a particular concrete UI 110 can be rendered by instantiating a portion of the corresponding concrete UI controller class 211. In such embodiments, the UI actions 223 can be instantiated from the corresponding concrete UI controller class 211 when needed, e.g., when user input is received to perform a specific UI action. In yet other embodiments, the entirety of a particular UI 220 can be instantiated at the same time.

FIG. 3 illustrates a detailed diagram of a framework 300 for sharing mandatory and shared UI functions using a UI controller 215, according to various embodiments of the present disclosure. As shown, a specific concrete UI 110 instantiates 231 and be associated with a corresponding UI controller class 211. In the specific example shown, the concrete UI 110 can include concrete UI specific common parameters 331, at least one individual UI function call 333, and individual UI function specific parameters 335. In such embodiments, each individual UI function call 333 can be associated with or include individual UI function specific parameters 335 that can be used in place of default parameters 327 when the particular function associated with the particular UI function call 333 is called from the shared function delegation class 215. Accordingly, a developer can customize any of the shared UI functions from the shared function delegation class 215 by defining individual function specific parameters 335.

In response to a request for a particular UI function or action from a user, or another component of the application in which concrete UI 110 is used, the corresponding concrete UI controller class 211 can be instantiated. Once the corresponding concrete UI controller class 211 is instantiated with the associated mandatory UI function superclass 250 and shared function delegation class 215, the individual UI function call 333 can reference the call 315 for an individual function with or without function specific parameters. The call 315 can delegate the requested function to the individual function method 325 in the shared function delegation class 215. The individual function method 325 can execute the requested function with the default parameters 327. The default parameters 327 can be set for all of the UIs associated with a particular application and/or the main business object 231. Alternatively, the shared function delegation class 215 can execute the set common parameters of a concrete UI method 323 that references the concrete UI specific common parameter 321. Concrete UI specific common parameter 321 references the concrete UI specific common parameter 312 and concrete UI specific common parameter 331. Effectively, the concrete UI specific common parameter 331 from the concrete UI 110 is passed through the concrete UI controller 210 to the shared function delegation class 215. Accordingly, a developer can set the concrete UI specific common parameter 331 in the concrete UI 110 that can then be used in the specified function when delegated as the individual function method 325 in the shared function delegation class 215.

At runtime, the determination to use default or concrete UI specific parameters can depend on whether the individual function call 333 is associated with a set of individual UI function specific parameters 335 in the concrete UI 110. If the individual function call 333 is associated with one or more individual function specific parameters 335, then the individual function method 325 can use those parameters when executing the method. If, however, the individual UI function call 333 is not associated with individual function specific parameters 335, then the individual function method 325 can be executed using the default parameters 327 in the instantiated shared function delegation class 215. The flexibility provided by the ability to set the individual UI function specific parameters 335 improves the utility of the framework 200 when developing UIs that share various optional and mandatory UI functions. Similarly, allowing developers to rely on the default parameters 327 can improve the reliability and consistency of the UIs that share optional and mandatory UI functions. In addition, the ability to change the default parameter settings for all UIs that share such UI functions can provide for faster, more efficient, and universal upgrades, customization, and troubleshooting for the UIs that are associated with a particular business object.

FIG. 3 also illustrates how the UI controller 210 can be used to set common parameters for each concrete UI. The common parameters can include values for parameters common to all UIs that share the mandatory and shared UI functions available in the UI controller 210. In one embodiment, a particular concrete UI 110 can include a listing of concrete UI specific common parameters 331. The corresponding concrete controller class 211 can reference the UI specific common parameters 331 and use them as concrete UI specific common parameters 312. When the UI controller calls the method to set common parameters 313, the concrete UI specific common parameters 312 can be used. In addition, when the shared function delegation class 215 is instantiated, the function to set common parameters of the concrete UI 323 can reference the concrete UI specific common parameters 312 as concrete UI specific common parameters 321.

Finally, FIG. 3 illustrates how the mandatory functions of the mandatory UI function superclass 250 can be inherited by each of the concrete UI controller classes 211. Any individual UI function call 333 that includes a call for mandatory function can be instantiated immediately when the concrete UI controller class 211 is instantiated. The mandatory UI functions can be executed using the default parameters values defined by the UI developer or the end user. In other embodiments, the mandatory UI functions can be executed using the individual UI function specific parameters 335 defined by the UI developer or the end user. As such, the framework 200 provides a flexible and organized way to share mandatory and shared functions among various UIs that are associated with or operate on the same main business object 231.

FIG. 4 is a flowchart of a method 400 for sharing mandatory and shared UI functions among multiple UIs supported by the same underlying main business object 231, according to various embodiments of the present disclosure. The method can begin once a main business object 231 is instantiated from a corresponding particular concrete UI 110. The UI controller 210 can receive an indication of a particular UI action, e.g., a function call, from the concrete UI 110, in action 410. For example, the indication can include user input generated in response to a user operating, manipulating, or otherwise entering input through one or more elements or controls of the concrete UI 110, e.g., pull-down menus, tabs, buttons, sliders, text fields, etc. In response to the indication of a UI action, the UI controller 210 can trigger a corresponding shared UI function from the corresponding instantiated concrete UI controller class 211, in action 415. In some embodiments, triggering the UI function can include determining whether the indicated UI action corresponds to a mandatory or shared UI function. In some embodiments, method 400 can include a separate determination 420 to determine whether the triggered action is associated with a mandatory UI function or shared UI function. If the triggered action is determined to be associated with a mandatory UI function, then method 400 can proceed to execute the mandatory UI function method with default or UI specific parameters, in action 423. As discussed herein, the mandatory UI function method corresponding to the triggered action, can be inherited from a mandatory UI function superclass in the UI controller.

In situations in which the UI controller determines that the triggered action is associated with a shared UI function, the method 400 can proceed to determine if the delegation class that includes the associated UI function has been instantiated, in determination 425. If the delegation class that includes the shared UI function associated with the triggered action is already instantiated, the method 400 can proceed to determination 440, in which the UI controller can determine whether the shared UI function should be called with concrete UI specific parameters defined in the concrete UI 110 through which the UI action was received. If the UI controller determines that the shared function delegation class associated with the triggered action has not yet been instantiated, then the UI controller can instantiate the corresponding concrete UI controller class 211 that includes the shared function delegation class 215, in action 430. Once the UI controller 210 has instantiated the corresponding shared function delegation class 215, the UI controller 210 can also set common parameters for the corresponding shared UI function, in action 435.

In some embodiments, the determination whether to call the shared function delegation class 211 using concrete UI specific parameters 335 can be based on the presence of such concrete UI specific parameters 335 in the UI action 223 or the concrete UI 110 through which the UI action 223 was received. Accordingly, if no concrete UI specific parameters 335 are passed from the concrete UI 110, then the UI controller 210 can determine that there are no concrete UI specific parameters 335 in determination 440. In other embodiments, the concrete UI 110 through which the UI action 223 is received can include a flag, toggle, or other selection to indicate whether the UI action 223 is associated with concrete UI specific parameters 335. In cases in which the UI controller 210 determines there are no concrete UI specific parameters 335, method 400 executes one or more individual function methods using the default parameters, in action 445. In situations in which the UI controller 210 determines to call the individual function method in the shared function delegation class using concrete UI specific parameters 335, the UI controller 210 can execute one or more individual function methods using the concrete UI function specific 335 received from the associated concrete UI, in action 443.

FIG. 5 illustrates an example computer system and networks that may be used to implement various embodiments of the present disclosure. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including instructions for performing the techniques described above. This memory may also be used for storing temporary variables or other intermediate information during execution of instructions to be executed by processor 501. Possible implementations of this memory may be, but are not limited to, random access memory (RAM), read only memory (ROM), or both. A storage device 503 is also provided for storing information and instructions. The information instructions can be in the form of computer readable code stored on the storage device, accessible and executable by processor to implement various techniques and methods of the present disclosure. Common forms of storage devices include non-transient, non-volatile computer readable media, for example, a hard drive, a magnetic disk, an optical disk, a CD, a DVD, a flash memory, a USB memory card, or any other medium from which a computer can read.

Computer system 510 may be coupled via the same or different information bus, such as bus 505, to a display 512, such as a cathode ray tube (CRT) or liquid crystal display (LCD), for displaying information. An input device 511 such as a keyboard and/or mouse is coupled to a bus for communicating information and command selections from the user to processor 501. The combination of these components allows the user to communicate with the system.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 504 sends and receives electrical, electromagnetic, or optical signals that carry digital data streams representing various types of information.

Computer system 510 can send and receive information, including messages or other interface actions, through the network interface 504 to an Intranet or the Internet 530. In the Internet example, software components or services may reside on multiple different computer systems 510 or servers 531 across the network. Software components described above may be implemented on one or more servers. A server 531 may transmit messages from one component, through Internet 530, local network 520, and network interface 504 to a component or container on computer system 510, for example. Software components of a composite application may be implemented on the same system as other components, or on a different machine than other software components. This process of sending and receiving information between software components or one or more containers may be applied to communication between computer system 510 and any of the servers 531 to 535 in either direction. It may also be applied to communication between any two servers 531 to 535.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A method comprising:
providing, by a computer system, a user interface controller comprising:
a superclass for implementing a plurality of mandatory user interface functions;
a delegation class for implementing a plurality of shared user interface functions; and
a plurality of concrete user interface controller classes corresponding to a plurality of concrete user interfaces that are associated with a main business object, wherein the plurality of concrete user interface classes inherit the plurality of mandatory user interface functions from the superclass and selectively delegate shared user interface functions to the delegation class;
receiving, by the computer system, a first function call from a first concrete user interface in the plurality of concrete user interfaces;
instantiating, by the computer system, in response to the first function call, a first corresponding concrete user interface controller class in the plurality of concrete user interface controller classes; and
executing, by the computer system, a first user interface function from the first corresponding concrete user interface controller class.

2. The method of claim 1 wherein the first user interface function comprises a first shared user interface function in the plurality of shared user interface functions.

3. The method of claim 2 wherein executing the first shared user interface function comprises instantiating the delegation class.

4. The method of claim 1 wherein instantiating the first corresponding concrete user interface controller class comprises executing a delegation class method in the delegation class.

5. The method of claim 4 further comprises passing, by the computer system, a concrete user interface specific parameter associated with the first concrete user interface to the delegation class method.

6. The method of claim 4 further comprising setting default parameters associated with the plurality of concrete user interfaces in the delegation class method.

7. The method of claim 1 wherein the mandatory user interface functions comprises user interface functions for passing user interface specific parameters to the first user interface function.

8. A non-transitory computer readable medium comprising instructions, that when executed by a computer processor configures the computer processor for:
providing a user interface controller comprising:
a superclass for implementing a plurality of mandatory user interface functions;
a delegation class for implementing a plurality of shared user interface functions; and
a plurality of concrete user interface controller classes corresponding to a plurality of concrete user interfaces that are associated with a main business object, wherein the plurality of concrete user interface classes inherit the plurality of mandatory user interface functions from the superclass and selectively delegate shared user interface functions to the delegation class;
receiving a first function call from a first concrete user interface in the plurality of concrete user interfaces;
instantiating in response to the first function call, a first corresponding concrete user interface controller class in the plurality of concrete user interface controller classes; and
executing a first user interface function from the first corresponding concrete user interface controller class.

9. The non-transitory computer readable medium of claim 8 wherein the first user interface function comprises a first shared user interface function in the plurality of shared user interface functions.

10. The non-transitory computer readable medium of claim 9 wherein executing the first shared user interface function comprises instantiating the delegation class.

11. The non-transitory computer readable medium of claim 8 wherein instantiating the first user interface function comprises executing a delegation class method in the delegation class.

12. The non-transitory computer readable medium of claim 11 wherein the instructions further configure the computer processor for passing a concrete user interface specific parameter associated with the first concrete user interface to the delegation class method.

13. The non-transitory computer readable medium of claim 11 wherein the instructions further configure the computer processor for setting default parameters associated with the plurality of concrete user interfaces in the delegation class method.

14. The non-transitory computer readable medium of claim 8 wherein the mandatory user interface functions comprises user interface functions for passing user interface specific parameters to the first user interface function.

15. A system comprising:
one or more computer processors; and
a computer readable medium comprising instructions, that when executed configures the one or more computer processors for:
providing a user interface controller comprising:
a superclass for implementing a plurality of mandatory user interface functions;
a delegation class for implementing a plurality of shared user interface functions; and
a plurality of concrete user interface controller classes corresponding to a plurality of concrete user interfaces that are associated with a main business object, wherein the plurality of concrete user interface classes inherit the plurality of mandatory user interface functions from the superclass and selectively delegate shared user interface functions to the delegation class;
receiving a first function call from a first concrete user interface in the plurality of concrete user interfaces;
instantiating in response to the first function call, a first corresponding concrete user interface controller class in the plurality of concrete user interface controller classes; and
executing a first user interface function from the first corresponding concrete user interface controller class.

16. The system of claim 15 wherein the first user interface function comprises a first shared user interface function in the plurality of shared user interface functions.

17. The system of claim 16 wherein executing the first shared user interface function comprises instantiating the delegation class.

18. The system of claim 17 wherein instantiating the first user interface function comprises executing a delegation class method in the delegation class.

19. The system of claim 18 wherein the instructions further configure the computer processor for:
passing, by the computer system, a concrete user interface specific parameter associated with the first concrete user interface to the delegation class method; and
setting common parameters of the first concrete user interface in the delegation class method.

20. The system of claim 19 wherein the instructions further configure the computer processor for setting default parameters associated with the plurality of concrete user interfaces in the delegation class method.
